(19) United States
(12) Patent Application Publication
(10) Pub. No.: US 2005/0157783 A1
(43) Pub. Date: Jul. 21, 2005

(54) Adaptive bandwidth allocation method and system for AV signal distribution

(75) Inventor: Takaaki Ota, San Diego, CA (US)

Correspondence Address: O'BANION & RITCHEY LLP/ SONY ELECTRONICS, INC., 400 CAPITOL MALL, SUITE 1550, SACRAMENTO, CA, 95814, US

(73) Assignees: SONY CORPORATION; SONY ELECTRONICS INC.

(21) Appl. No.: 10/759,869

(22) Filed: Jan. 15, 2004

(51) Int. Cl. H04N 7/12

(52) U.S. Cl. 375/240.03; 375/240.01

(57) ABSTRACT

A method for controlling audio/visual signal distribution includes receiving an input signal and prefiltering the input signal. Plural quantized coefficients are generated from the input signal and have a variable coarseness. The plural quantized coefficients are encoded and transmitted to a transmission buffer. During operation, the occupancy level within the transmission buffer is monitored. Based on the occupancy level, the coarseness of the plural quantized coefficients is varied accordingly.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to audio/visual systems, and more particularly to bandwidth allocation in audio/visual signal distribution systems.

2. Description of Related Art

In a home AV signal distribution system, when signals are distributed from a server, or some other gateway, to receivers in different rooms, the signal is usually digitally compressed in order to go through a narrower digital channel than the original bandwidth of the signal. Depending on the clients' capability and need, compression parameters (e.g., spatial/temporal resolution and compression ratio) must be appropriately configured prior to the signal transmission. Moreover, to cope with time-varying characteristics of channels, the compression parameters must change dynamically while the system is in use to avoid system overflow. Some of such time-varying channel characteristics are RF wireless bandwidth which can vary depending on moving objects in the vicinity of the signal's transmission path or the number of clients that share the same channel which can change in time by clients joining and leaving the system.

It is possible to control compression parameters dynamically by observing the time varying channel characteristics. However, it is not easy. This situation can be analogous to controlling the speed of a car (i.e., data generation rate) that follows another car running ahead at random speed (i.e., available band width). The goal is to keep the distance between two cars constant (i.e., avoid overflow or underflow of a buffer) as the car ahead changes its speed randomly. If the following car's speed (i.e., data generation rate) is matched to the speed of the leading car (i.e., available band width) by observing its speed, the reaction delay is inevitable. And, depending on the linearity of the delay, the distance between two cars may drift farther or closer indefinitely which can cause buffer overflow or underflow.

The present invention recognizes the present drawbacks and provides a solution to one or more of the problems associated therewith.

### BRIEF SUMMARY OF THE INVENTION

The present invention pertains generally to addressing bandwidth limitations in audio/visual distribution systems which include a digital data generator and a transmitter connected to the digital data generator, wherein the data is transmitted to a receiver over a communications link. In accordance with one aspect of the invention, the present invention includes a data transmission buffer and associated load distribution logic. In accordance with another aspect of the invention, the load distribution logic monitors the “occupancy level” in the in the data transmission buffer. In the event that there is an occupancy level in the data transmission buffer, that is, when the data transmission buffer is not emptying normally due to insufficient bandwidth over the communications link, the load distribution logic reduces the data rate of the digital data generator.

In one beneficial embodiment of the present invention, the data transmission buffer is positioned between the digital data generator and the data transmitter. The load distribution logic is connected to the data transmission buffer and the digital data generator.

In an embodiment of an audio/visual signal distribution system with adaptive bandwidth allocation according to the present invention the preferred system includes a prefiltering and spatial/temporal subsampler. Moreover, a frequency domain quantizer is connected to the prefiltering and spatial/temporal subsampler. A transmission buffer is connected to the frequency domain quantizer, and a load distribution logic module is connected to the prefiltering and spatial/temporal subsampler, the frequency domain quantizer, and the transmission buffer. The load distribution logic module includes logic for controlling the coarseness of the frequency domain quantization by the frequency domain quantizer based on occupancy level within the transmission buffer.

In a preferred embodiment, the load distribution logic module also includes logic for controlling the coarseness of subsampling by the prefiltering and spatial/temporal subsampler. Further, a motion compensation orthogonal transform module is connected between the prefiltering and spatial/temporal subsampler and the frequency domain quantizer. An encoder is connected between the frequency domain quantizer and the transmission buffer. The encoder encodes quantized coefficients from the frequency domain quantizer. It can be appreciated that the quantized coefficients can be run-length encoded and/or entropy encoded. Preferably, a best-effort transmitter is connected to the transmission buffer and a receiver is connected to the best-effort transmitter.

In another embodiment, a method for controlling audio/visual signal distribution includes allocating a buffer to a transmitter and a receiver. A channel connected to the buffer is run, or otherwise executed, in the best effort mode. When an available bandwidth within the channel is compared to a data generation rate through the channel, the result is reflected on the accumulation of data within the buffer.

In a still further embodiment, a method for controlling audio/visual signal distribution includes receiving an input signal and prefiltering the input signal. Plural quantized coefficients are generated from the input signal and have a variable coarseness. The plural quantized coefficients are encoded and transmitted to a transmission buffer. During operation, the occupancy level within the transmission buffer is monitored. Based on the occupancy level, the coarseness of the plural quantized coefficients is varied accordingly.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of an audio/visual signal distribution system that employs adaptive bandwidth allocation according to the present invention.

FIG. 2 is a flow chart of the generalized signal distribution logic according to the present invention.

FIG. 3 is a flow chart of the signal distribution logic according to the present invention.

FIG. 4 is a block diagram of an alternative embodiment of a system employing adaptive bandwidth allocation according to the present invention wherein the data generator is a transcoder.

FIG. 4 is a block diagram of an alternative embodiment of a system employing adaptive bandwidth allocation according to the present invention wherein the data generator is a compressor which receives a baseband signal.

FIG. 4 is a block diagram of an alternative embodiment of a system employing adaptive bandwidth allocation according to the present invention wherein the data generator is a decompressor and compressor system (transcoder) which receives both compressed and baseband signals.

### DETAILED DESCRIPTION OF THE INVENTION

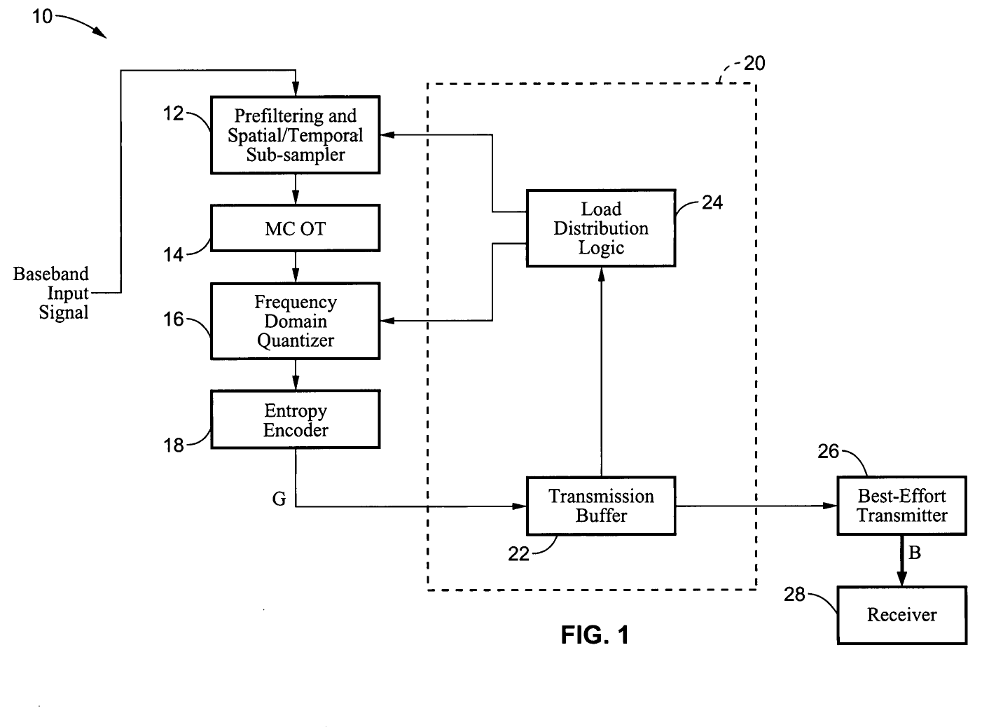

Referring more specifically to the drawings, for illustrative purposes the present invention is embodied in the apparatus and methods generally illustrated in FIG. 1 through FIG. 6. It will be appreciated that the apparatus may vary as to configuration and as to details of the parts, and that the method may vary as to the specific steps and sequence, without departing from the basic concepts as disclosed herein.

Referring initially to FIG. 1, an example of an audio/visual signal distribution system employing the present invention is shown and is generally designated 10. In the example shown, the system 10 includes a prefiltering and spatial/temporal subsampler 12 that is connected to a motion compensated orthogonal transform (MCOT) module 14, such as a discrete cosine transform (DCT) module. The MCOT module 14 is employed if an input signal, received by the prefiltering and spatial/temporal subsampler 12, is compressed using motion pictures experts group (MPEG) compression. FIG. 1 shows that the MCOT module 14 is connected to a frequency domain quantizer 16 that controls the compression ratio of the input signal.

As shown in FIG. 1, an entropy encoder 18 is connected to the frequency domain quantizer. The entropy encoder 18 encodes the quantized coefficients from the frequency domain quantizer to yield a stream of data for transmission where the data has a data rate G in this example. Prior to transmission, the data pass through a data rate control module 20 according to the present invention that comprises a transmission buffer 22 and load distribution logic 24 which will be described in more detail below. A best-effort transmitter 26 is connected to the transmission buffer 22 and, during operation, pulls data as fast as it can from the transmission buffer 22. The best-effort transmitter 26 is connected to a receiver 28 such as a set top box connected to television. The connection, which has a bandwidth B, can be a wired connection, wireless connection, the Internet, a power-line carrier connection, or any other connection which may experience bandwidth constraints. FIG. 1 also shows that, in the example illustrated, load distribution logic module 24 is connected to the prefiltering and spatial/temporal subsampler 12, the frequency domain quantizer 16, and the transmission buffer 22. As described in detail below, load distribution logic module 24 includes load distribution logic that can be used to control the data generation rate from the frequency domain quantizer 16 based on the occupancy level within the transmission buffer 22.

The benefits of the invention derive from the ability to reduce data rates when the data rate exceeds the available bandwidth. In normal operation, G<B which means that there sufficient bandwidth for data transmission and the transmission buffer 22 will empty. However, in the event that the available bandwidth is less than the data rate, the transmission buffer 22 will start to hold data. Hence, there will be a data occupancy level in the transmission buffer 22. Hence, the invention comprises data rate control module 20 and its method of operation, which can be employed in essentially any audio/visual distribution system where digital data is generated for transmission over a communications link.

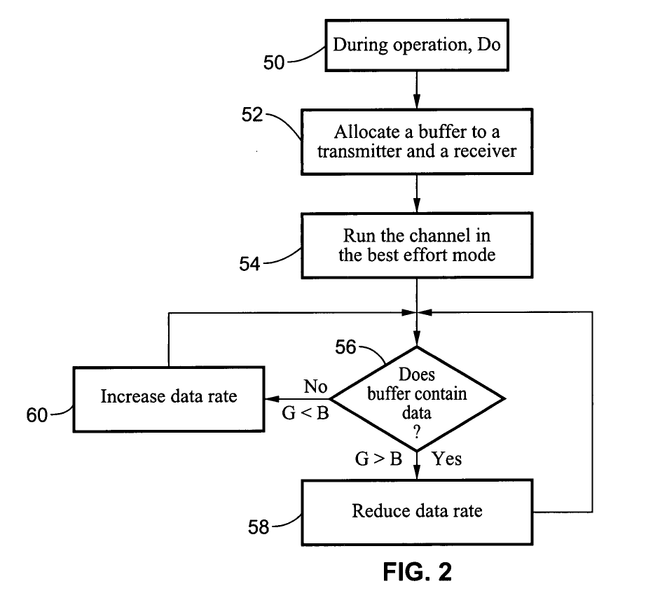

Referring now to FIG. 2, the generalized load distribution logic according to the present invention is shown in the context of FIG. 1 and block 24 where the logic is implemented using a programmed data processor or the like. As illustrated, the process commences at block 50 with a do loop wherein during operation, the following steps are performed. At block 52, the transmission buffer 22 (FIG. 1) is allocated to the best-effort transmitter 26 (FIG. 1) and the receiver 28 (FIG. 1). Thereafter, at block 54, the signal channel to the buffer is run, or otherwise executed, in the best effort mode well known in the art.

Moving to decision diamond 56, it is determined whether the transmission buffer 22 contains data, that is, has an occupancy level. If the occupancy level is zero, then the buffer is emptying normally because the available bandwidth, B, is greater than or equal the data generation rate, G. In that case, the data rate can optionally be increased at block 60. If transmission buffer 22 contains data, then B is less than Gand the logic continues to block 58 where the data rate is decreased. It can be appreciated that if there is not any data within the transmission buffer, then there cannot be a reduction in data within the buffer. Moreover, if B is equal to G, then the reduction in data within the transmission buffer is zero. In this regard, it is to be noted that it is not necessary to actually measure B and G, although one could optionally make those measurements. So long as there is data in the transmission buffer, then a reduction in data rate is required. The feedback would typically be optimized on the basis of the characteristics of the data channel.

Referring still to FIG. 2, it will therefore be appreciated that one mode of the inventive method comprises the operations carried out in blocks 56 and 58, which provide for reduction of the data rate from the data generator when an occupancy level is detected in the transmission buffer. Another mode of the inventive method comprises the additional operations carried out in block 60 which provides for increasing the data rate from the data generator when the buffer is emptying normally and there are no bandwidth constraints.

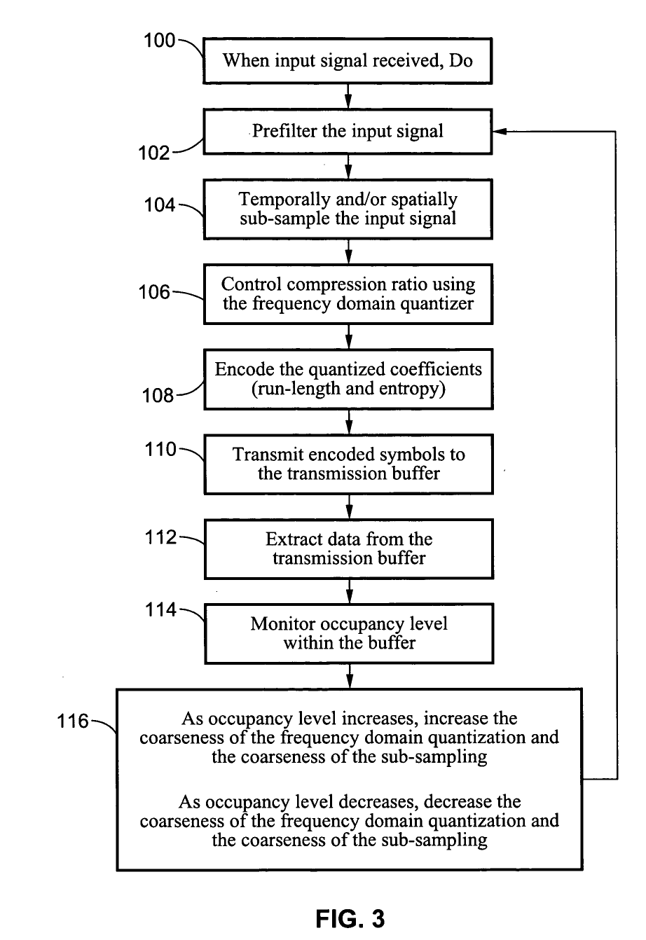

FIG. 3 shows a preferred, non-limiting embodiment of the load distribution logic according to the present invention, again in the context of the system shown in FIG. 1. Commencing with a do loop at block 100, when an input signal is received, the succeeding steps are performed. At block 102, the input signal is prefiltered. Additionally, at block 104, the input signal is temporally and/or spatially sub-sampled if necessary. It can be appreciated that the prefiltering and subsampling can be undertaken within the prefiltering and spatial/temporal subsampler 12 (FIG. 1).

Continuing to block 106, in the case that the signal is compressed using MPEG compression, the compression ratio is controlled using the frequency domain quantizer 16 (FIG. 1). Next, at block 108, the quantized coefficients from the frequency domain quantizer 16 are run-length encoded and entropy encoded within the entropy encoder 18 (FIG. 1). Moving to block 110, the encoded symbols are transmitted to the transmission buffer 20 (FIG. 1). Thereafter, data is extracted from the transmission buffer 20 (FIG. 1) by the best-effort transmitter 22 (FIG. 1).

Proceeding to block 114, the occupancy level within the buffer is monitored while the above steps are performed. At block 116, as the occupancy level within the buffer increases, the coarseness of the frequency domain quantization and the coarseness of the subsampling is increased. It is to be understood that this causes the data (e.g., symbol) generation rate from the frequency domain quantizer to become coarser. On the other hand, as the occupancy level within the buffer decreases, the coarseness of the frequency domain quantization and the coarseness of the subsampling is decreased. This causes the data generation rate from the frequency domain quantizer to become less coarse.

From the foregoing, it will be appreciated that when more than one signal shares a single transmission channel, a plurality of the above-described systems can be easily combined by, for example, placing a multiplexer after each transmission buffer to combine the data.

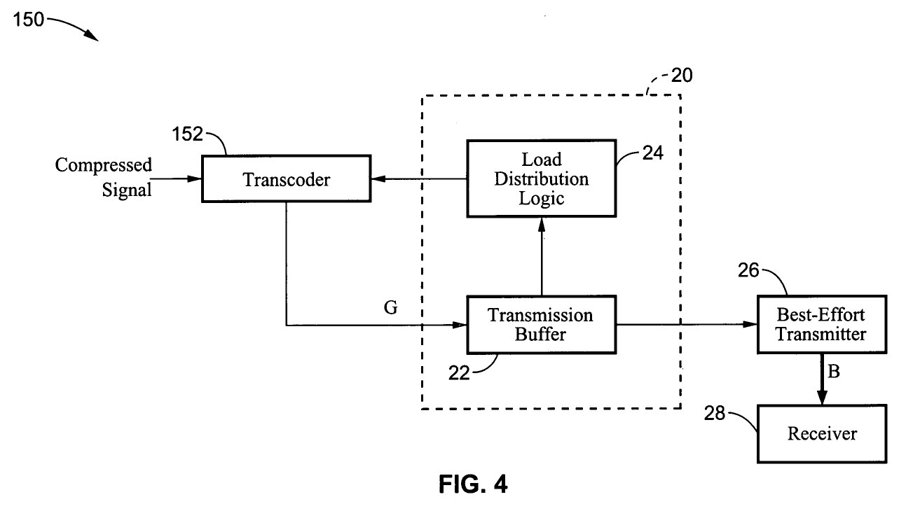

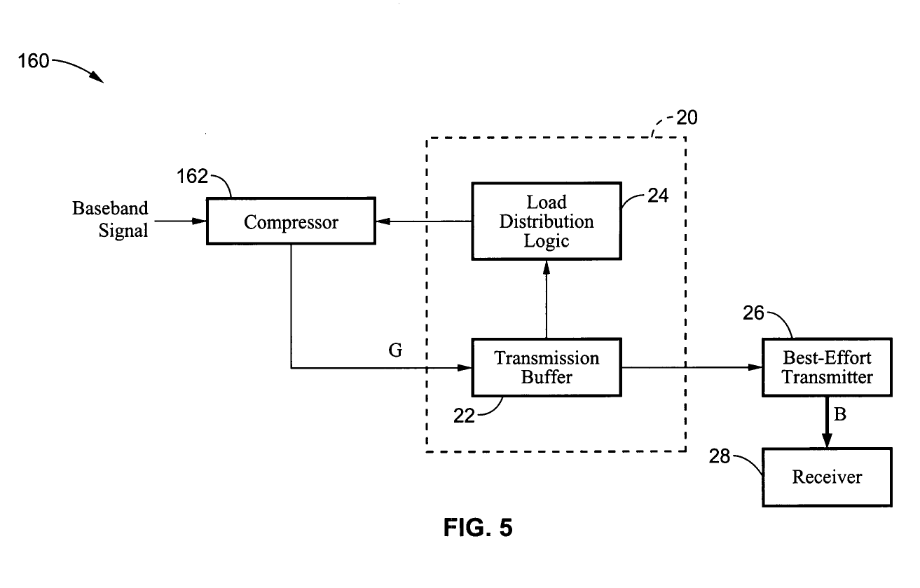

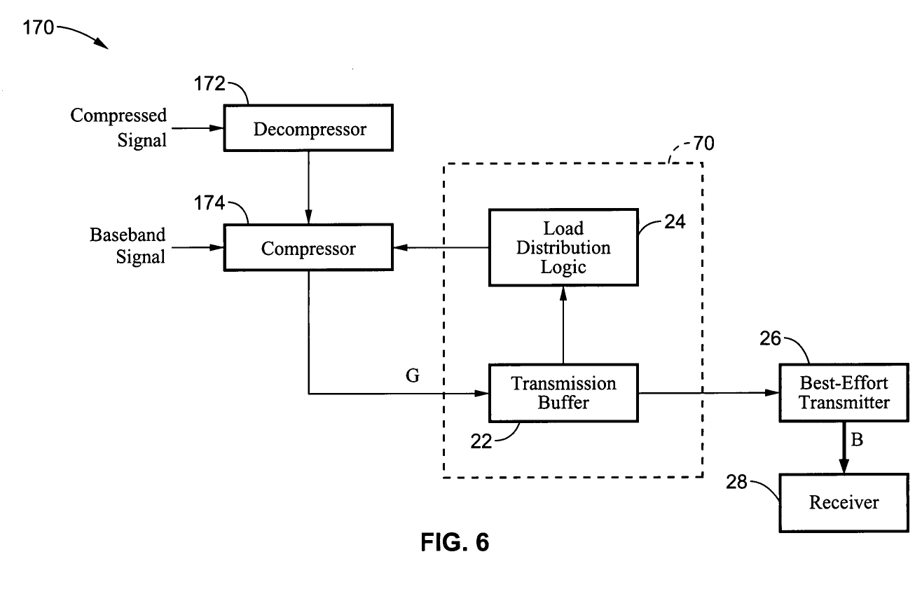

With the configuration of structure described above, the system and method according to the present invention can be used to control the flow of data to a receiver based on the available bandwidth, e.g., within a network connection, leading to the receiver. From the foregoing discussion, it will be appreciated that the invention can also be used in combination with various digital data generator configurations such as those shown in FIG. 4, FIG. 5 and FIG. 6. In FIG. 4, the system 150 receives a compressed signal and decompresses the signal in a data generator comprising a transcoder 152. In the system 160 shown in FIG. 5, the system receives a baseband signal and compresses the signal in data generator comprising compressor 162. FIG. 6 shows a system 170 in which a combination of a compressed and baseband signals are received and processed by a transcoder comprising decompressor 172 and compressor 174.

Hence, it will be appreciated that, in accordance with the present invention, the occupancy level in a transmission buffer is monitored and, if there is data in the buffer, the data rate is reduced to accommodate a bandwidth restriction. On the other hand, when there is sufficient bandwidth to accommodate the data rate, the buffer empties normally and no data rate reduction is required. Those skilled in the art will also appreciate that the data transmission buffer can be implemented in any conventional manner known in the art, and that the load distribution logic can be implemented in software or firmware associated with a programmed data processor, as well as in hardware if desired.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. In an audio/visual signal distribution system having a digital data generator connected to a transmitter, said transmitter configured to transmit said digital data over a communications link to a receiver, the improvement comprising:
a data transmission buffer connected between the digital data generator and the transmitter; and
a load distribution logic module connected to the data generator and to the data transmission buffer;
wherein the load distribution logic module is configured to control the data rate of the data generator based on occupancy of data in said data transmission buffer.

2. An improved audio/visual system as recited in claim 1, wherein said data transmission buffer has an occupancy level when the data rate is greater than the available bandwidth over the communications link.

3. An improved audio/visual system as recited in claim 2, wherein said data transmission buffer empties when the available bandwidth over the communications link is greater than the data rate.

4. An apparatus for adaptive bandwidth allocation in an audio/visual distribution system having a digital data generator connected to a transmitter, said transmitter configured to transmit said digital data over a communications link to a receiver, said apparatus comprising:
a data transmission buffer configured for connection between the digital data generator and the transmitter; and
a load distribution logic module configured for connection to the data generator and to the data transmission buffer;
wherein the load distribution logic module is configured to control the data rate of the data generator based on occupancy of data in said data transmission buffer.

5. An apparatus as recited in claim 4, wherein said data transmission buffer has an occupancy level when the data rate is greater than the available bandwidth over the communications link.

6. An apparatus as recited in claim 5, wherein said data transmission buffer empties when the available bandwidth over the communications link is greater than the data rate.

7. A method for adaptive bandwidth allocation in an audio/visual distribution system having a digital data generator connected to a transmitter, said transmitter configured to transmit said digital data over a communications link to a receiver, said method comprising:
providing a data transmission buffer positioned between the digital data generator and the transmitter;
providing a load distribution logic module connected to the data generator and to the data transmission buffer; and
controlling the data rate of the data generator based on occupancy of data in said data transmission buffer.

8. A method as recited in claim 7, wherein said data transmission buffer has an occupancy level when the data rate is greater than the available bandwidth over the communications link.

9. A method as recited in claim 8, wherein said data transmission buffer empties when the available bandwidth over the communications link is greater than the data rate.

10. An audio/visual signal distribution system with adaptive bandwidth allocation, comprising:
a data generation device;
a transmitter, said transmitter configured to transmit data from said data generation device over a communications link to a receiver;
a transmission buffer positioned between the data generation device and the transmitter; and
a load distribution logic module connected to the data generation device and to the transmission buffer;
wherein the load distribution logic controls the data rate of the data generated by the data generation device based on data occupancy level in the transmission buffer.

11. A system as recited in claim 10, wherein said data transmission buffer has an occupancy level when the data rate is greater than the available bandwidth over the communications link.

12. A system as recited in claim 11, wherein said data transmission buffer empties when the available bandwidth over the communications link is greater than the data rate.

13. A system as recited in claim 10, further comprising:
a prefiltering and spatial/temporal subsampler; and
a frequency domain quantizer connected to the prefiltering and spatial/temporal subsampler;
wherein the load distribution logic module further includes logic for controlling a coarseness of subsampling by the prefiltering and spatial/temporal subsampler.

14. A system as recited in claim 13, further comprising:
a motion compensation orthogonal transform module connected between the prefiltering and spatial/temporal subsampler and the frequency domain quantizer.

15. A system as recited in claim 14, further comprising:
an encoder connected between the frequency domain quantizer and the transmission buffer, the encoder encoding quantized coefficients from the frequency domain quantizer.

16. A system as recited in claim 15, wherein the quantized coefficients are run-time encoded.

17. A system as recited in claim 15, wherein the quantized coefficients are entropy encoded.

18. A system as recited in claim 15, wherein said transmitter comprises a best-effort transmitter.

19. A method for controlling audio/visual signal distribution, comprising:
allocating a buffer to a transmitter and a receiver;
running a channel connected to the buffer in a best effort mode;
comparing an available bandwidth within the channel to a data generation rate through the channel; and
based on the comparison, controlling an accumulation of data within the buffer.

20. A method for controlling audio/visual signal distribution, comprising:
receiving an input signal;
prefiltering the input signal;
generating plural quantized coefficients from the input signal, the plural quantized coefficients having a variable coarseness;
encoding the plural quantized coefficients;
transmitting plural encoded quantized coefficients to a transmission buffer;
monitoring an occupancy level within the transmission buffer;
increasing the coarseness of the plural quantized coefficients as the occupancy level within the transmission buffer increases; and
decreasing the coarseness of the plural quantized coefficients as the occupancy level within the transmission buffer decreases.
